(19) United States
(12) Patent Application Publication
(10) Pub. No.: US 2019/0345335 A1
(43) Pub. Date: Nov. 14, 2019

(54) Preparation method of polyorganosiloxane-polycarbonate and its application

(71) Applicant: Guangdong Great Material Co., Ltd., Dongguan (CN)

(72) Inventors: Zhixiong LONG, Dongguan (CN); Tian XIA, Dongguan (CN)

(21) Appl. No.: 16/403,328

(22) Filed: May 3, 2019

(30) Foreign Application Priority Data
May 9, 2018 (CN) 201810437917.6

(51) Int. Cl. C08L 83/10; C08G 77/448; C08J 3/22; C08J 3/12

(52) U.S. Cl. CPC C08L 83/10; C08G 77/448; C08J 3/226; C08L 2201/08; C08L 2310/00; C08L 2201/02; C08J 3/12

(57) ABSTRACT

The invention relates to the technical field of polymer materials, in particular to a preparation method of polyorganosiloxane-polycarbonate and its application. The preparation method includes the following steps: A: The preparation of polycarbonate terminated by acyl chloride. B: Preparation of polyorganosiloxane-polycarbonate. In the invention, the polyorganosiloxane-polycarbonate has excellent mechanical properties due to the introduction of polydimethylsiloxane terminated by eugenol in the main chain. In particular, the polysiloxane-polycarbonate has high low temperature impact strength, low ductility/brittleness transition temperature and good flame retardancy. In the invention, the polycarbonate modified by the Polyorganosiloxane-polycarbonate has good flexural strength, tensile strength and flame retardancy.

### FIELD OF THE INVENTION

The invention relates to the technical field of polymer materials, in particular to a preparation method of polyorganosiloxane-polycarbonate and its application.

### BACKGROUND OF THE INVENTION

Polycarbonate (PC) is one of the five major engineering plastics, it has many excellent properties, such as high mechanical strength, high heat resistance, good electrical insulation and dimensional stability, so widely used in many fields such as machinery, aviation, transportation, optics, electronics, agriculture, textile, medical treatment and so on. However, PC has increasingly exposed its own shortcomings in the practical application, showing that the notched impact strength of PC is poor at low temperature, which seriously limits its application in severe cold areas or low temperature environments. The flame retardant grade of PC (UL94 V2) does not meet the requirements for the use of high flame retardant products in certain areas. In addition, PC (bisphenol A type) has high melt viscosity and difficult processing because of its high rigidity and large steric hindrance of molecular chain, so it is difficult to make large products.

Organosilicon polymers have excellent resistance to high and low temperature, weather resistance, dielectric property, intrinsic flame retardant, combustion will produce non-flammable silica ash and self-extinguish, and gas emission toxicity belongs to the low toxicity range. The low surface energy can effectively improve the movement ability of polymer segments. Silicone polymers have long been an important additive for PC in foreign countries, which is used to improve the processing fluidity, notch sensitivity, flame retardancy and low temperature impact properties of PC. However, the effect of directly adding organosilicon to PC is not ideal, which is mainly due to the poor compatibility of the two methods.

The formula (CN106398234A) components was designed as follows: Polycarbonate polydimethylsiloxane: 92-94%, halogen-free flame retardant 0.1-0.12%, toughening agent 4-6%, anti-drop agent 0.5-0.6%, main antioxidant 0.1-0.2%, auxiliary antioxidant 0.3-0.4%, lubricant 0.4-0.5%, The weather proof agent 0.3-0.5%. The invention considers that polycarbonate polydimethylsiloxane copolymer has good mechanical and electrical properties. The low temperature impact strength of polycarbonate polydimethylsiloxane copolymer is high because of the introduction of polydimethylsiloxane chain into polycarbonate. In addition, polydimethylsiloxane when it is combusting can promote the carbon formation of PC, and has good synergistic flame retardant effect with additive flame retardants, and can effectively reduce the amount of flame retardants. The invention aims to provide a halogen-free flame retardant and cold-resistant PC material suitable for charging pile charging gun and a preparation method. In the patent, the polycarbonate polydimethylsiloxane copolymer is selected from Korea Sanyang 3020PJ, which appears to reduce the use of other additives, but the raw material itself is expensive, and almost entirely dependent on import companies, it is very easy to appear out of stock, out of stock phenomenon.

### SUMMARY OF THE INVENTION

In order to overcome the shortcomings and shortcomings of the prior art, the first purpose of the invention provides a preparation method of polyorganosiloxane-polycarbonate, which has a high molecular weight and a narrow molecular weight distribution, high impact strength at low temperature and low cost.

The second purpose of the invention provides a modified polycarbonate, using the polysiloxane-polycarbonate combined with other additives to modify the polycarbonate, so that it has good bending strength, tensile strength and flame retardancy.

The third purpose of the invention provides a preparation method of modified polycarbonate by adopting specific process steps and process parameters, the modified polycarbonate with good bending strength and tensile strength and superior flame retardant property is prepared.

the first purpose of the invention is realized through the following technical scheme: Preparation method of polyorganosiloxane-polycarbonate includes the following steps:

A: Preparation of polycarbonate terminated by acyl chloride:

A1: Using transesterification method by adding bisphenol A to diphenyl carbonate and under the action of composite catalyst. Low molecular weight polycarbonate is created. The molar ratio of diphenyl carbonate to bisphenol A is 1:1.3-1.6.

A2: Before adding an acyl chloride capping agent to the reaction product of step A1, inert gas is used for protection, temperature is controlled at 160-180° C. First, constant temperature for 30-45 min, then, vacuum extraction is operated, then, constant temperature for 15-20 min, and then, cooling to 40° C.-60° C., the polycarbonate with end-capped acyl chloride is acquired.

B: Preparation of polyorganosiloxane-polycarbonate:

B1: Inert gas is used for protection, and then adding polyorganosiloxane to the mixture of diphenyl carbonate and magnesium chloride, transesterification reaction is carried out under the state of stirring and molten condition. The mass ratio of diphenyl carbonate, magnesium chloride and polydimethylsiloxane is 50-70:15-30:1.

B2: Adding the acyl chloride-terminated polycarbonate obtained from step A2 wherein said into the reaction product of step B1, then, under the conditions of inert gas protection, stirring and heating to cause the polycondensation reaction to take place. After the reaction is finished, cooling to normal temperature, the crude product of polyorganosilicone-polycarbonate is obtained.

B3: The crude product of polycarbonate obtained by step B2 wherein said is dissolved into organic solution, washed by alcohol solvent and filtered, and then the polyorganosiloxane-polycarbonate is obtained after it's dried.

The preparation method of the invention, low molecular weight polycarbonate is produced by non-phosgene synthesis and using excessive bisphenol A and diphenyl carbonate. Then polycarbonate and bisphenol A terminated by acyl chloride is prepared by adding the acyl chloride capping agent to the reaction system. Acyl chloride capping has high activity, it is easier to complete the polymerization with the products of polysiloxane and diphenyl carbonate, and obtain polyorganosiloxane-polycarbonate with large molecular weight and narrow molecular weight distribution. In the preparation of polyorganosiloxane-polycarbonate, first, diphenyl carbonate is polymerized with polyorganosiloxane to form a polymer of diphenyl carbonate and polyorganosiloxane. Second, adding polycarbonate terminated by acyl chloride and bisphenol A terminated by acyl chloride, they polymerize with the resulting mixture of diphenyl carbonate and polyorganosiloxane, leading to a further increase in the molecular chain. Finally, polyorganosiloxane-polycarbonate is precipitated by alcohol solvent. Polysiloxane-polycarbonate (Block polymerization) with the method of preparation in the invention has large molecular weight and narrow distribution of molecular weight, weight average molecular weight is 40000-60000, dispersity index is 1.5-2.2.

The advantages of polyorganosiloxane-polycarbonate prepared by the invention contain: large molecular weight, narrow molecular weight distribution, high impact strength at low temperature and normal temperature, simple preparation method, high controllability, low cost, it can realize industrial scale production, it has practical application value and can promote the synthesis and development of polyorganosiloxane-polycarbonate.

In the invention, the polyorganosiloxane-polycarbonate has excellent mechanical properties due to the introduction of polydimethylsiloxane into the main chain, and higher low temperature impact strength and lower ductility/brittleness transition temperature.

Preferably, in the step A1 wherein said, the non-phosgene synthesis comprises a transesterification phase and a polycondensation stage, and the specific steps in the transesterification phase are as follows: The first step is that the temperature of diphenyl carbonate is rised to 100° C.-120° C. under inert gas protection. The second step is that bisphenol A is added and then the time of keeping temperature is 30-45 min. The third step is that the prepolymer is prepared by heating up to 150° C.-180° C. and the time of keeping temperature is 1-2 H. The specific steps of the condensation phase are as follows: The first step is that the temperature of the prepolymer is rised to 200° C.-220° C. under inert gas protection and then the time of keeping temperature is 45-60 min. The second step is that causing the temperature to rise to 240-270° C. and the time of keeping temperature is 1-2 H. The third step is that the reaction is kept 15-30 min under the condition of vacuum. Low molecular weight polycarbonate is acquired.

In the preparation method of the invention, bisphenol A is added to the diphenyl carbonate, the bisphenol A reacts fully with the diphenyl carbonate, and the molecular weight of the synthesized polycarbonate is as large as possible. Further, the synthesis of polysiloxane-polycarbonate has a large molecular weight and narrow distribution.

Preferably, in the step A1 wherein said, the additive amount of the composite catalyst said is 0.4%-3% of the mass of the bisphenol A. The composite catalyst is composed of catalyst A and catalyst B, the molar ratio of A:B said is 1:0.8-1.5. The catalyst A said is one or more of the tetraphenyl phosphonium benzene oxide, tetraphenyl phosphonium acetate and phenol tetraphenyl phosphonium salts. The catalyst B said is one or more of t-butyllithium, t-butylpotassium, cesium tert-butyl, tert-butyl, n-butyllithium, n-butyl, n-butyl, and n-butylcaesium.

In the invention, it has better catalytic effect than the single catalyst by adopting the composite catalyst. After the composite catalyst of in the invention is added to the initial product, synthesis reaction in the later is no need to add any other catalyst, and the reaction efficiency is improved. More preferably, the catalyst A said is phenol tetraphenyl phosphonium salts; the catalyst B said is n-butyllithium. Catalyst A and catalyst B cooperate with each other in the reaction to make the molecular weight of the polymer as large as possible and the molecular weight distribution as low as possible.

Preferably, the molar ratio of total diphenyl carbonate in steps A1 and B1 wherein said to bisphenol A in step A1 is 1:1.1-1.2. In the step A2 wherein said, the molar ratio of acyl chloride capping agent to bisphenol A is 5-10:1.

In the invention, by controlling the molar ratio of total diphenyl carbonate to bisphenol A in step A1 wherein said is 1:1.1-1.2, the amount of bisphenol A is slightly more than that of diphenyl carbonate, diphenyl carbonate is completely reacted. The polyorganosiloxane-polycarbonate produced has high molecular weight and narrow molecular weight distribution. By controlling the molar ratio of acyl chloride capping agent to bisphenol A is 5-10:1, the excess bisphenol A and the low molecular weight polycarbonate produced can be completely capped by acyl chloride. In order to facilitate the subsequent reaction with diphenyl carbonate and polyorganosiloxane, polyorganosiloxane-polycarbonate with high molecular weight and narrow molecular weight distribution was formed.

Preferably, in the step A2 wherein said, the acyl chloride capping agent said is vinyl benzenesulfonyl chloride and/or methyl propionyl chloride. In the step B1 wherein said, the polysiloxane said is a polydimethylsiloxane terminated by eugenol. The weight-average molecular weight of the polysiloxane said is 2500-3200, and the polydispersity index is less than 3.5.

In the invention, it has better reaction activity by using vinyl benzenesulfonyl chloride or methyl propionyl chloride, and polycarbonate and bisphenol A can be successfully sealed by acyl chloride. More preferably, the acyl chloride capping agent is composed of vinyl benzenesulfonyl chloride and methacryloyl chloride with a molar ratio of 2-3:1. The acyl chloride capping reaction of bisphenol A and polycarbonate can be promoted better than the single acyl chloride end-sealing agent by the compound acyl chloride end-capping agent. The compound acyl chloride end-capping agent make the end-capping efficiency of acyl chloride higher, subsequent polymerization more beneficial, the molecular weight of polyorganosiloxane-polycarbonate obtained high and the molecular weight distribution of polyorganosiloxane-polycarbonate obtained narrow. In the invention, polyorganosiloxane-polycarbonate blocked by polyorganosiloxane can be obtained by using polydimethylsiloxane terminated by dieugenol. The polyorganosiloxane-polycarbonate with a weight average molecular weight of 40000-60000 and a dispersion index of 1.5-2.2 is prepared by using polyorganosiloxane with a weight average molecular weight of 2500-3200 and a polydispersity index of less than 3.5.

Preferably, in the step B1 wherein said, the reaction temperature is 100° C.-120° C., at the end of the reaction, the product is cooled to 40° C.-60° C. In the step B2, the reaction temperature is 120° C.-150° C., and the time of keeping temperature is 45-60 min, and then vacuum extraction is operated, and then the time of keeping temperature is 15-20 min, the last the polyorganosiloxane-polycarbonate crude product is acquired by cooling down to normal atmospheric temperature.

In the invention, polyorganosiloxane-polycarbonate is formed by the polycarbonate and bisphenol A terminated by acyl chloride and the polymer of diphenyl carbonate with polyorganosiloxane. Because of the high activity of acyl chloride, the reaction temperature of polyorganosiloxane-polycarbonate is lower than that of traditional transesterification method, and the controllability of polyorganosiloxane-polycarbonate is higher than that of traditional transesterification method. Therefore, the industrial scale production can be realized.

Preferably, in the step B3 wherein said, organic solvents are one or more of dichloromethane, trichloromethane, dichloroethane, trichloroethane, tetrachloroethane, toluene, and chlorobenzene. Alcohol solvents are one or more of methanol, ethyl alcohol, propanol and butanol.

In the invention, polyorganosiloxane-polycarbonate with high purity is obtained by dissolving the crude product of polyorganosiloxane-polycarbonate in organic solvent and then washing it with alcohol solvent. More preferably, Organic solvent is dichloromethane, alcohol solvent is composed of methanol and ethanol by volume ratio of 1:2-3. The compound alcohol solvent has better extraction effect than a single alcohol solvent, and it has higher purity for polyorganosiloxane-polycarbonate obtained, and better effect on the modification effect of the polycarbonate.

Preferably, In the step B3 wherein said, the weight-average molecular weight of the Polyorganosiloxane-polycarbonate is 40000-60000, and the polydispersity index is 1.5-2.2. The weight percentage of the polycarbonate block said is 70%-85%, and the polysiloxane block said is 15%-30%.

The polyorganosiloxane-polycarbonate prepared by the preparation method of the invention has high molecular weight, narrow molecular weight distribution, high low temperature impact strength and low cost. The polyorganosiloxane-polycarbonate that the weight average molecular weight is 40000˜60000 and the dispersion index is 1.5˜2.2 is prepared by controlling the amount of polysiloxane, diphenyl carbonate and bisphenol A added, adding the polysiloxane-polycarbonate with the weight percentage of 15%-30% of polysiloxane block obtained by adding polyorganosiloxane terminated by dieugenol, the specific process steps and process parameters of the invention adopted.

The second purpose of the invention provides a modified polycarbonate, includes raw materials weights as follow:
Polycarbonate: 100 PHR
Polyorganosiloxane-polycarbonate: 20-40 PHR
Hyperbranched polymer: 1-5 PHR
Halogen-free flame retardant: 0.1-0.6 PHR
Toughening agent: 0.5-4 PHR
Anti-drop agent: 0.3-0.5 PHR
Antioxidant: 0.16-0.3 PHR
Light stabilizer: 0.2-0.4 PHR
Dispersant: 0.4-0.5 PHR

The polyorganosiloxane-polycarbonate is prepared by the above-mentioned preparation method.

The invention adopts polycarbonate as the resin matrix, because hyperbranched polymer is added, the effective melt viscosity of the polycarbonate is significantly reduced, the processing temperature is reduced, and the apparent property of the polycarbonate plastic is improved. It can improve the yield strength, tensile modulus, notched cantilever impact strength and bending strength of polycarbonate, and then improve the mechanical properties and processing properties. At the same time, the hyperbranched polymer is ammonia-terminated hyperbranched polyamide, containing a large number of active functional groups, so that the flame retardant added can be dispersed more evenly in the polycarbonate matrix. The compatibility of flame retardant and polycarbonate resin matrix is increased. The modified polycarbonate has good flexural strength, tensile strength and flame retardant properties up to UL94 V0 (0.8 mm). More preferably, The polycarbonate said is bisphenol A polycarbonate, the hyperbranched polymer said is an amino-terminated hyperbranched polyamide, and the toughening agent said is One or more kinds of silicone acrylic resin, high silicon resin and MBS (Core-shell toughening Agent of Methyl Methacrylate-Butadiene-Styrene). The halogen-free flame retardant said is one or more of diphenylsulfone potassium sulfonate, potassium perfluorobutyl sulfonate, sesquisilicon flame retardant and resorcinol bis (diphenyl) phosphate ester. The anti-dropping agent said is modified PTFE and/or modified fluorinated silicon polymer. The antioxidant said comprises main antioxidant and accessory antioxidant at a mass ratio of 3.2-4.5:1. The main antioxidant said is tetrakis [β-(3,5-uncle Ding Ji-4-hydroxyphenyl) propionic acid] pentaerythritol ester and/or β-(3,5-tert Ding Ji-4-hydroxyphenyl) propionic acid n-octadecyl alcohol ester. The accessory antioxidants said are one or more of the tris (2,4-di-tert-butylphenyl) phosphite, tetra (2,4-di-tert-Ding Ji-4,4′-yl) diester, bis (2.4-di-tert-butylphenyl) pentaerythritol diphosphite and four (2,4-di-tert-butylphenyl) pentaerythritol diphosphite. The light stabilizer said is 2-(2H-benzotriazole-2-yl)-4,6-bis (1-methyl-1-phenylethyl) phenol. The dispersant said is PETS (pentaerythritol stearate).

The third purpose of the invention is to provide a preparation method of modified polycarbonate, includes the following steps:
(1) The polycarbonate and polyorganosiloxane-polycarbonate are dried at 100° C.-120° C. for 2 h-4 h.
(2) Hyperbranched polymers, flame retardants and partially polysiloxane-polycarbonate are mixed homogeneously, the mixing speed is 1000-1200 r/min, and the mixing time is 5-8 min, the flame retardant plastic masterbatch is prepared by extrusion granulation.
(3) The Homogeneous mixture contains the flame retardant masterbatch prepared in step (2), polycarbonate, antioxidant and the remaining polyorganosiloxane-polycarbonate and extruded to form plastic masterbatch.
(4) The toughening agent, anti-dropping agent, light stabilizer and dispersant are predispersed to obtain the pre-dispersed mixture.
(5) The product of step (3) is added to the pre-dispersed mixture of the Step (4) wherein said, and the mixture is evenly mixed. Modified polycarbonate is acquired by extrusion granulation.

Wherein, the step (2), the step (3) and the step (5) wherein said are all extruded by a twin screw extruder.

In the step (2) wherein said, the temperature of each area of twin screw extruder is: the first area: 210-230° C., the second area: 250-260° C., the third area: 270-280° C., the fourth area: 270-280° C., the fifth area: 270-280° C., the sixth area: 270-280° C., the seventh area: 250-260° C., the eighth area: 250-260° C., the ninth area: 270-280° C., extruder head temperature: 270-280° C.

In the step (3) wherein said, the temperature of each area of twin screw extruder is: the first area: 180-200° C., the second area: 210-230° C., the third area: 220-240° C., the fourth area: 220-240° C., the fifth area: 220-240° C., the sixth area: 220-240° C., the seventh area: 210-230° C., the eighth area: 210-230° C., the ninth area: 220-240° C., extruder head temperature: 160-180° C.

In the step (5) wherein said, the temperature of each area of twin screw extruder is: the first area: 180-200° C., the second area: 210-230° C., the third area: 220-240° C., the fourth area: 220-240° C., the fifth area: 220-240° C., the sixth area: 220-240° C., the seventh area: 210-230° C., the eighth area: 210-230° C., the ninth area: 220-240° C., extruder head temperature: 160-180° C., The rotating speed of twin screw extruder is 350-400 r/min, the feed quantity is 170-180 kg/h, the vacuum degree is ≥600 mm Hg, and the temperature of water cooling is 40-65° C.

In the invention, the hyperbranched polymer and the polycarbonate are extruded into granulation, the hyperbranched polymer has a large number of active functional groups, so that the halogen-free flame retardant can be better adsorbed on the surface of the polycarbonate and uniformly dispersed in the polycarbonate. Finally, it can be used lower processing temperature and higher controllability with other additives to extrude granulation. Excessive processing temperature can lead to oxidation of polycarbonate and polyorganosiloxane-polycarbonate. Finally, the modified polycarbonate of the invention has good bending strength, tensile strength and flame retardant properties up to UL94 V0 (0.8 mm). In the step (2), the amount of polyorganosiloxane-polycarbonate mixed with flame retardant is one fifth of the total amount of polyorganosiloxane-polycarbonate.

The invention has the following advantages: the preparation method of the invention, low molecular weight polycarbonate is produced by non-phosgene synthesis and using excessive bisphenol A and diphenyl carbonate. Then polycarbonate and bisphenol A terminated by acyl chloride is prepared by adding the acyl chloride capping agent to the reaction system. Acyl chloride capping has high activity, it is easier to complete the polymerization with the products of polysiloxane and diphenyl carbonate, and obtain polyorganosiloxane-polycarbonate with large molecular weight and narrow molecular weight distribution. In the preparation of polyorganosiloxane-polycarbonate, first, diphenyl carbonate is polymerized with polyorganosiloxane to form a polymer of diphenyl carbonate and polyorganosiloxane. Second, adding polycarbonate terminated by acyl chloride and bisphenol A terminated by acyl chloride, they polymerize with the resulting mixture of diphenyl carbonate and polyorganosiloxane, leading to a further increase in the molecular chain. Finally, polyorganosiloxane-polycarbonate is precipitated by alcohol solvent. Polysiloxane-polycarbonate (Block polymerization) with the method of preparation in the invention has large molecular weight and narrow distribution of molecular weight, weight average molecular weight is 40000-60000, dispersity index is 1.5-2.2.

The advantages of polyorganosiloxane-polycarbonate prepared by the invention contain: large molecular weight, narrow molecular weight distribution, high impact strength at low temperature and normal temperature, simple preparation method, high controllability, low cost, it can realize industrial scale production, it has practical application value and can promote the synthesis and development of polyorganosiloxane-polycarbonate.

In the invention, the polyorganosiloxane-polycarbonate has excellent mechanical properties due to the introduction of polydimethylsiloxane into the main chain, and higher low temperature impact strength and lower ductility/brittleness transition temperature.

In the invention, the polycarbonate modified by the polyorganosiloxane-polycarbonate has good bending strength, tensile strength and flame retardant properties up to UL94 V0 (0.8 mm).

The preparation method of the modified polycarbonate of the invention is that the modified polycarbonate has good bending strength and tensile strength and superior flame retardant performance by adopting specific process steps and process parameters.

### DESCRIPTION OF THE PREFERRED EMBODIMENTS

In order to facilitate the understanding of the technical personnel in the field, the present invention is further explained in the light of embodiments below, and the contents referred to in the embodiment are not limited to the present invention.

### The Implementation Example 1

Preparation method of polyorganosiloxane-polycarbonate includes the following steps:

A: Preparation of polycarbonate terminated by acyl chloride:

A1: Using transesterification method by adding bisphenol A to diphenyl carbonate and under the action of composite catalyst. Low molecular weight polycarbonate is created. The molar ratio of diphenyl carbonate to bisphenol A is 1:1.3.

A2: Before adding an acyl chloride capping agent to the reaction product of step A1, inert gas is used for protection, temperature is controlled at 160° C. First, constant temperature for 45 min, then, Vacuum extraction is operated, then, Constant temperature for 20 min, and then, cooling to 40° C., the polycarbonate with end-capped acyl chloride is acquired.

B: Preparation of polyorganosiloxane-polycarbonate:

B1: Inert gas is used for protection, and then adding polyorganosiloxane to the mixture of diphenyl carbonate and magnesium chloride, transesterification reaction is carried out under the state of stirring and molten condition. The mass ratio of diphenyl carbonate, magnesium chloride and polydimethylsiloxane is 50:15:1.

B2: Adding the acyl chloride-terminated polycarbonate obtained from step A2 wherein said into the reaction product of step B1, then, under the conditions of inert gas protection, stirring and heating to cause the polycondensation reaction to take place. After the reaction is finished, cooling to normal temperature, the crude product of polyorganosilicone-polycarbonate is obtained.

B3: The crude product of polycarbonate obtained by step B2 wherein said is dissolved into organic solution, washed by alcohol solvent and filtered, and then the polyorganosiloxane-polycarbonate is obtained after it's dried.

In the step A1 wherein said, the non-phosgene synthesis comprises a transesterification phase and a polycondensation stage, and the specific steps in the transesterification phase are as follows: The first step is that the temperature of diphenyl carbonate is rised to 100° C. under inert gas protection. The second step is that bisphenol A is added and then the time of keeping temperature is 45 min. The third step is that the prepolymer is prepared by heating up to 150° C. and the time of keeping temperature is 2 H. The specific steps of the condensation phase are as follows: The first step is that the temperature of the prepolymer is rised to 200° C. under inert gas protection and then the time of keeping temperature is 60 min. The second step is that causing the temperature to rise to 240° C. and the time of keeping temperature is 2 H. The third step is that the reaction is kept 30 min under the condition of vacuum. Low molecular weight polycarbonate is acquired.

In the step A1, the additive amount of the composite catalyst said is 0.4% of the mass of the bisphenol A. The composite catalyst said is composed of catalyst A and catalyst B, the molar ratio of A:B is 1:0.8. The catalyst A said is tetraphenyl phosphonium benzene oxide and tetraphenyl phosphonium acetate, the mass ratio of them is 1:0.8. The catalyst B said is t-butyllithium.

The molar ratio of total diphenyl carbonate in steps A1 and B1 wherein said to bisphenol A in step A1 is 1:1.1. In the step A2 wherein said, the molar ratio of acyl chloride capping agent to bisphenol A is 5:1.

In the step A2 wherein said, the acyl chloride capping agent said is vinyl benzenesulfonyl chloride. In the step B1 wherein said, the polysiloxane said is a polydimethylsiloxane terminated by eugenol. The weight-average molecular weight of the polysiloxane said is 2500, and the polydispersity index is 3.5.

In the step B1 wherein said, the reaction temperature is 100° C., at the end of the reaction, the product is cooled to 40° C. In the step B2, the reaction temperature is 120° C., and the time of keeping temperature is 60 min, and then vacuum extraction is operated, and then the time of keeping temperature is 20 min, the last the polyorganosiloxane-polycarbonate crude product is acquired by cooling down to normal atmospheric temperature.

In the step B3 wherein said, organic solvents is dichloromethane. Alcohol solvents is methanol.

In the step B3 wherein said, the weight-average molecular weight of the polyorganosiloxane-polycarbonate is 40000, and the polydispersity index is 1.5. The weight percentage of the polycarbonate block said is 70%, and the polysiloxane block said is 30%.

### The Implementation Example 2

Preparation method of polyorganosiloxane-polycarbonate includes the following steps:

A: Preparation of polycarbonate terminated by acyl chloride:

A1: Using transesterification method by adding bisphenol A to diphenyl carbonate and under the action of composite catalyst. Low molecular weight polycarbonate is created. The molar ratio of diphenyl carbonate to bisphenol A is 1:1.6.

A2: Before adding an acyl chloride capping agent to the reaction product of step A1, inert gas is used for protection, temperature is controlled at 180° C. First, constant temperature for 30 min, then, Vacuum extraction is operated, then, Constant temperature for 15 min, and then, cooling to 60° C., the polycarbonate with end-capped acyl chloride is acquired.

B: Preparation of polyorganosiloxane-polycarbonate:

B1: Inert gas is used for protection, and then adding polyorganosiloxane to the mixture of diphenyl carbonate and magnesium chloride, transesterification reaction is carried out under the state of stirring and molten condition. The mass ratio of diphenyl carbonate, magnesium chloride and polydimethylsiloxane is 70:30:1.

B2: Adding the acyl chloride-terminated polycarbonate obtained from step A2 wherein said into the reaction product of step B1, then, under the conditions of inert gas protection, stirring and heating to cause the polycondensation reaction to take place. After the reaction is finished, cooling to normal temperature, the crude product of polyorganosilicone-polycarbonate is obtained.

B3: The crude product of polycarbonate obtained by step B2 wherein said is dissolved into organic solution, washed by alcohol solvent and filtered, and then the polyorganosiloxane-polycarbonate is obtained after it's dried.

In the step A1 wherein said, the non-phosgene synthesis comprises a transesterification phase and a polycondensation stage, and the specific steps in the transesterification phase are as follows: The first step is that the temperature of diphenyl carbonate is rised to 120° C. under inert gas protection. The second step is that bisphenol A is added and then the time of keeping temperature is 30 min. The third step is that the prepolymer is prepared by heating up to 180° C. and the time of keeping temperature is 1 H. The specific steps of the condensation phase are as follows: The first step is that the temperature of the prepolymer is rised to 220° C. under inert gas protection and then the time of keeping temperature is 45 min. The second step is that causing the temperature to rise to 270° C. and the time of keeping temperature is 1 H. The third step is that the reaction is kept 15 min under the condition of vacuum. Low molecular weight polycarbonate is acquired.

In the step A1 wherein said, the additive amount of the composite catalyst said is 3% of the mass of the bisphenol A. The composite catalyst said is composed of catalyst A and catalyst B, the molar ratio of A:B is 1:1.5. The catalyst A said is phenol tetraphenyl phosphonium salts. The catalyst B said is n-butyllithium.

The molar ratio of total diphenyl carbonate in steps A1 and B1 wherein said to bisphenol A in step A1 is 1:1.2. In the step A2 wherein said, the molar ratio of acyl chloride capping agent to bisphenol A is 10:1. Preferably, n the step A2 wherein said, the acyl chloride capping agent said is vinyl benzenesulfonyl chloride or methyl propionyl chloride. In the step B1 wherein said, the polysiloxane said is a polydimethylsiloxane terminated by eugenol. The weight-average molecular weight of the polysiloxane said is 3200, and the polydispersity index is 1.5.

In the step B1 wherein said, the reaction temperature is 120° C., at the end of the reaction, the product is cooled to 60° C. In the step B2, the reaction temperature is 150° C., and the time of keeping temperature is 45 min, and then vacuum extraction is operated, and then the time of keeping temperature is 15 min, the last the polyorganosiloxane-polycarbonate crude product is acquired by cooling down to normal atmospheric temperature.

In the step B3 wherein said, organic solvents is chloroform. Alcohol solvents is alcohol.

In the step B3 wherein said, the weight-average molecular weight of the Polyorganosiloxane-polycarbonate is 50000, and the polydispersity index is 2.2. The weight percentage of the polycarbonate block said is 85%, and the polysiloxane block said is 15%.

### The Implementation Example 3

Preparation method of polyorganosiloxane-polycarbonate includes the following steps:

A: Preparation of polycarbonate terminated by acyl chloride:

A1: Using transesterification method by adding bisphenol A to diphenyl carbonate and under the action of composite catalyst. Low molecular weight polycarbonate is created. The molar ratio of diphenyl carbonate to bisphenol A is 1:1.5.

A2: Before adding an acyl chloride capping agent to the reaction product of step A1, inert gas is used for protection, temperature is controlled at 170° C. First, constant temperature for 40 min, then, vacuum extraction is operated, then, Constant temperature for 18 min, and then, cooling to 50° C., the polycarbonate with end-capped acyl chloride is acquired.

B: Preparation of polyorganosiloxane-polycarbonate:

B1: Inert gas is used for protection, and then adding polyorganosiloxane to the mixture of diphenyl carbonate and magnesium chloride, transesterification reaction is carried out under the state of stirring and molten condition. The mass ratio of diphenyl carbonate, magnesium chloride and polydimethylsiloxane is 60:25:1.

B2: Adding the acyl chloride-terminated polycarbonate obtained from step A2 wherein said into the reaction product of step B1, then, under the conditions of inert gas protection, stirring and heating to cause the polycondensation reaction to take place. After the reaction is finished, cooling to normal temperature, the crude product of polyorganosilicone-polycarbonate is obtained.

B3: The crude product of polycarbonate obtained by step B2 wherein said is dissolved into organic solution, washed by alcohol solvent and filtered, and then the polyorganosiloxane-polycarbonate is obtained after it's dried.

In the step A1 wherein said, the non-phosgene synthesis comprises a transesterification phase and a polycondensation stage, and the specific steps in the transesterification phase are as follows: The first step is that the temperature of diphenyl carbonate is rised to 110° C. under inert gas protection. The second step is that bisphenol A is added and then the time of keeping temperature is 35 min. The third step is that the prepolymer is prepared by heating up to 165° C. and the time of keeping temperature is 1-2 H. The specific steps of the condensation phase are as follows: The first step is that the temperature of the prepolymer is rised to 210° C. under inert gas protection and then the time of keeping temperature is 50 min. The second step is that causing the temperature to rise to 260° C. and the time of keeping temperature is 1.5 H. The third step is that the reaction is kept 20 min under the condition of vacuum. Low molecular weight polycarbonate is acquired.

In the step A1 wherein said, the additive amount of the composite catalyst said is 2% of the mass of the bisphenol A. The composite catalyst said is composed of catalyst A and catalyst B, the molar ratio of A:B is 1:1.2. The catalyst A said is tetraphenyl phosphonium benzene oxide and phenol tetraphenyl phosphonium salts, the mass ratio of them is 1:2. The catalyst B said is t-butyllithium and n-butyllithium, the mass ratio of them is 1:2-3.

The molar ratio of total diphenyl carbonate in steps A1 and B1 wherein said to bisphenol A in step A1 is 1:1.1. In the step A2 wherein said, the molar ratio of acyl chloride capping agent to bisphenol A is 8:1.

In the step A2 wherein said, the acyl chloride capping agent said is vinyl benzenesulfonyl chloride or methyl propionyl chloride. In the step B1 wherein said, the polysiloxane said is a polydimethylsiloxane terminated by eugenol. The weight-average molecular weight of the polysiloxane said is 3000, and the polydispersity index is 2.

In the step B1 wherein said, the reaction temperature is 110° C., at the end of the reaction, the product is cooled to 50° C. In the step B2, the reaction temperature is 135° C., and the time of keeping temperature is 50 min, and then vacuum extraction is operated, and then the time of keeping temperature is 18 min, the last the polyorganosiloxane-polycarbonate crude product is acquired by cooling down to normal atmospheric temperature.

In the step B3 wherein said, organic solvents is dichloromethane, chloroform and dichloroethane, mixed according to the volume ratio of 2-3:1:1. Alcohol solvents is methanol and alcohol, mixed according to the volume ratio of 2:1.

In the step B3 wherein said, the weight-average molecular weight of the Polyorganosiloxane-polycarbonate is 60000, and the polydispersity index is 1.5. The weight percentage of the polycarbonate block said is 80%, and the polysiloxane block said is 20%.

### The Implementation Example 4

A modified polycarbonate includes raw materials weights as follow:
Polycarbonate: 100 PHR
Polyorganosiloxane-polycarbonate: 20 PHR
Hyperbranched polymer: 1 PHR
Halogen-free flame retardant: 0.1 PHR
Toughening agent: 0.5 PHR
Anti-drop agent: 0.3 PHR
Antioxidant: 0.16 PHR
Light stabilizer: 0.2 PHR
Dispersant: 0.4 PHR

The polyorganosiloxane-polycarbonate said is prepared in the implementation example 1.

Preparation method of modified polycarbonate is described wherein said, the following steps is included:
(1) The polycarbonate and polyorganosiloxane-polycarbonate are dried at 100° C. for 4 h.
(2) Hyperbranched polymers, flame retardants and partially polysiloxane-polycarbonate are mixed homogeneously, the mixing speed is 1000 r/min, and the mixing time is 8 min, the flame retardant plastic masterbatch is prepared by extrusion granulation.
(3) The Homogeneous mixture contains the flame retardant masterbatch prepared in step (2), polycarbonate, antioxidant and the remaining polyorganosiloxane-polycarbonate and extruded to form plastic masterbatch.
(4) The toughening agent, anti-dropping agent, light stabilizer and dispersant are predispersed to obtain the pre-dispersed mixture.
(5) The product of step (3) is added to the pre-dispersed mixture of the step (4) wherein said, and the mixture is evenly mixed. Modified polycarbonate is acquired by extrusion granulation.

Wherein, the step (2), the step (3) and the step (5) wherein said are all extruded by a twin screw extruder.

In the step (2) wherein said, the temperature of each area of twin screw extruder is: the first area: 210° C., the second area: 250° C., the third area: 270° C., the fourth area: 270° C., the fifth area: 270° C., the sixth area: 270° C., the seventh area: 250° C., the eighth area: 250° C., the ninth area: 270° C., extruder head temperature: 270° C.

In the step (3) wherein said, the temperature of each area of twin screw extruder is: the first area: 180° C., the second area: 210° C., the third area: 220° C., the fourth area: 220° C., the fifth area: 220° C., the sixth area: 220° C., the seventh area: 210° C., the eighth area: 210° C., the ninth area: 220° C., extruder head temperature: 160° C.

In the step (5) wherein said, the temperature of each area of twin screw extruder is: the first area: 180° C., the second area: 210° C., the third area: 220° C., the fourth area: 220° C., the fifth area: 220° C., the sixth area: 220° C., the seventh area: 210° C., the eighth area: 210° C., the ninth area: 220° C., extruder head temperature: 160° C., The rotating speed of twin screw extruder is 350 r/min, the feed quantity is 170 kg/h, the vacuum degree is ≥600 mm Hg, and the temperature of water cooling is 40° C.

### The Implementation Example 5

A modified polycarbonate includes raw materials weights as follow:
Polycarbonate: 100 PHR
Polyorganosiloxane-polycarbonate: 40 PHR
Hyperbranched polymer: 5 PHR
Halogen-free flame retardant: 0.6 PHR
Toughening agent: 4 PHR
Anti-drop agent: 0.5 PHR
Antioxidant: 0.3 PHR
Light stabilizer: 0.4 PHR
Dispersant: 0.5 PHR

The polyorganosiloxane-polycarbonate said is prepared in the implementation example 2.

Preparation method of modified polycarbonate is described wherein said, the following steps is included:
(1) The polycarbonate and polyorganosiloxane-polycarbonate are dried at 120° C. for 2 h.
(2) Hyperbranched polymers, flame retardants and partially polysiloxane-polycarbonate are mixed homogeneously, the mixing speed is 1200 r/min, and the mixing time is 5 min, the flame retardant plastic masterbatch is prepared by extrusion granulation.
(3) The Homogeneous mixture contains the flame retardant masterbatch prepared in step (2), polycarbonate, antioxidant and the remaining polyorganosiloxane-polycarbonate and extruded to form plastic masterbatch.
(4) The toughening agent, anti-dropping agent, light stabilizer and dispersant are predispersed to obtain the pre-dispersed mixture.
(5) The product of step (3) is added to the pre-dispersed mixture of the step (4) wherein said, and the mixture is evenly mixed. Modified polycarbonate is acquired by extrusion granulation.

Wherein, the step (2), the step (3) and the step (5) wherein said are all extruded by a twin screw extruder.

In the step (2) wherein said, the temperature of each area of twin screw extruder is: the first area: 230° C., the second area: 260° C., the third area: 280° C., the fourth area: 280° C., the fifth area: 280° C., the sixth area: 280° C., the seventh area: 260° C., the eighth area: 260° C., the ninth area: 280° C., extruder head temperature: 280° C.

In the step (3) wherein said, the temperature of each area of twin screw extruder is: the first area: 200° C., the second area: 230° C., the third area: 240° C., the fourth area: 240° C., the fifth area: 240° C., the sixth area: 240° C., the seventh area: 230° C., the eighth area: 230° C., the ninth area: 240° C., extruder head temperature: 180° C.

In the step (5) wherein said, the temperature of each area of twin screw extruder is: the first area: 200° C., the second area: 230° C., the third area: 240° C., the fourth area: 240° C., the fifth area: 240° C., the sixth area: 240° C., the seventh area: 230° C., the eighth area: 230° C., the ninth area: 240° C., extruder head temperature: 180° C., The rotating speed of twin screw extruder is 400 r/min, the feed quantity is 180 kg/h, the vacuum degree is ≥600 mm Hg, and the temperature of water cooling is 65° C.

### The Implementation Example 6

A modified polycarbonate includes raw materials weights as follow:
Polycarbonate: 100 PHR
Polyorganosiloxane-polycarbonate: 30 PHR
Hyperbranched polymer: 3 PHR
Halogen-free flame retardant: 0.3 PHR
Toughening agent: 2 PHR
Anti-drop agent: 0.4 PHR
Antioxidant: 0.22 PHR
Light stabilizer: 0.3 PHR
Dispersant: 0.45 PHR

The polyorganosiloxane-polycarbonate said is prepared in the implementation example 3.

Preparation method of modified polycarbonate is described wherein said, the following steps is included:
(1) The polycarbonate and polyorganosiloxane-polycarbonate are dried at 110° C. for 3 h.
(2) Hyperbranched polymers, flame retardants and partially polysiloxane-polycarbonate are mixed homogeneously, the mixing speed is 1100 r/min, and the mixing time is 6 min, the flame retardant plastic masterbatch is prepared by extrusion granulation.
(3) The Homogeneous mixture contains the flame retardant masterbatch prepared in step (2), polycarbonate, antioxidant and the remaining polyorganosiloxane-polycarbonate and extruded to form plastic masterbatch.
(4) The toughening agent, anti-dropping agent, light stabilizer and dispersant are predispersed to obtain the pre-dispersed mixture.
(5) The product of step (3) is added to the pre-dispersed mixture of the step (4) wherein said, and the mixture is evenly mixed. Modified polycarbonate is acquired by extrusion granulation.

Wherein, the step (2), the step (3) and the step (5) wherein said are all extruded by a twin screw extruder.

In the step (2) wherein said, the temperature of each area of twin screw extruder is: the first area: 220° C., the second area: 255° C., the third area: 275° C., the fourth area: 275° C., the fifth area: 275° C., the sixth area: 275° C., the seventh area: 255° C., the eighth area: 255° C., the ninth area: 275° C., extruder head temperature: 275° C.

In the step (3) wherein said, the temperature of each area of twin screw extruder is: the first area: 190° C., the second area: 220° C., the third area: 230° C., the fourth area: 230° C., the fifth area: 230° C., the sixth area: 230° C., the seventh area: 220° C., the eighth area: 220° C., the ninth area: 230° C., extruder head temperature: 170° C.

In the step (5) wherein said, the temperature of each area of twin screw extruder is: the first area: 190° C., the second area: 220° C., the third area: 230° C., the fourth area: 230° C., the fifth area: 230° C., the sixth area: 230° C., the seventh area: 220° C., the eighth area: 220° C., the ninth area: 230° C., extruder head temperature: 170° C., The rotating speed of twin screw extruder is 380 r/min, the feed quantity is 175 kg/h, the vacuum degree is ≥600 mm Hg, and the temperature of water cooling is 50° C.

### Contrast Example

A modified polycarbonate includes raw materials weights as follow:
Polycarbonate: 100 PHR
Hyperbranched polymer: 3 PHR
Halogen-free flame retardant: 2 PHR
Toughening agent: 1 PHR
Anti-drop agent: 0.4 PHR
Antioxidant: 0.22 PHR
Light stabilizer: 0.3 PHR
Dispersant: 0.45 PHR

The test properties of modified polycarbonate about the implementation example 4-6 and contrast example 1 are as follows:

| | Imple- | Imple- | Imple- | |
|---|---|---|---|---|
| | mentation | mentation | mentation | Contrast |
| | Example | Example | Example | Example |
| ITEMS | 4 | 5 | 6 | 1 |
| Bending Strength (MPa) | 88 | 89 | 90 | 85 |
| Tensile Strength(MPa) | 60 | 61 | 63 | 55 |
| Notched Impact Strength | 71 | 71 | 70 | 57 |
| of Cantilever Beam at | | | | |
| Room Temp.(KJ/M2) | | | | |
| Notched Impact Strength | 56 | 57 | 61 | 39 |
| Cantilever Beam At Low | | | | |
| Temp.(−40° C.) (KJ/M2) | | | | |
| UL94 Flame Retardant | V0 | V0 | V0 | HB |
| Grade (2.0 mm) | | | | |
| UL94 Flame Retardant | V1 | V1 | V1 | HB |
| Grade (1.6 mm) | | | | |
| Electric Indentation | 2 | 2 | 2 | 3 |
| Index(CTI) | | | | |
| Long-term Thermal | ≥70 | ≥70 | ≥70 | ≤30 |
| Aging Test Performance | | | | |
| Retention Rate (%) | | | | |
| Weathering Test | f1 | f1 | f1 | / |

From the table above, we can see, polycarbonate modified by polyorganosiloxane-polycarbonate was prepared by the invention. The physical properties of modified polycarbonate are obviously better than contrast example 1, for example, flexural strength, tensile strength, notched impact strength of cantilever beam at room temperature, notched impact strength of cantilever beam at low temperature, inflaming retarding, CTI, ageing resistance and weather fastness and so on. Polycarbonate modified by polyorganosiloxane-polycarbonate in the present invention has good flexural strength, tensile strength and flame retardant property up to UL94 V0 (0.8 mm).

The implementation example are better implementation schemes of the invention. In addition, the invention can also be realized in other ways. Any obvious replacement is within the protection scope of the invention without being separated from the conception of the invention.

What is claimed is:

1. Preparation method of polyorganosiloxane-polycarbonate includes the following steps:
A: Preparation of polycarbonate terminated by acyl chloride:
A1: Using transesterification method by adding bisphenol A to diphenyl carbonate and under the action of composite catalyst. Low molecular weight polycarbonate is created. The molar ratio of diphenyl carbonate to bisphenol A is 1:1.3-1.6.
A2: Before adding an acyl chloride capping agent to the reaction product of step A1, inert gas is used for protection, temperature is controlled at 160-180° C. First, constant temperature for 30-45 min, then, Vacuum extraction is operated, then, Constant temperature for 15-20 min, and then, cooling to 40° C.-60° C., the polycarbonate with end-capped acyl chloride is acquired.
B: Preparation of polyorganosiloxane-polycarbonate:
B1: Inert gas is used for protection, and then adding polyorganosiloxane to the mixture of diphenyl carbonate and magnesium chloride, transesterification reaction is carried out under the state of stirring and molten condition. The mass ratio of diphenyl carbonate, magnesium chloride and polydimethylsiloxane is 50-70:15-30:1.
B2: Adding the acyl chloride-terminated polycarbonate obtained from step A2 wherein said into the reaction product of step B1, then, under the conditions of inert gas protection, stirring and heating to cause the polycondensation reaction to take place. After the reaction is finished, cooling to normal temperature, the crude product of polyorganosilicone-polycarbonate is obtained.
B3: The crude product of polycarbonate obtained by step B2 wherein said is dissolved into organic solution, washed by alcohol solvent and filtered, and then the polyorganosiloxane-polycarbonate is obtained after it's dried.

2. According to claim 1 wherein said, the preparation method of polyorganosiloxane-polycarbonate is described, its characteristic includes: in the step A1 wherein said, the non-phosgene synthesis comprises a transesterification phase and a polycondensation stage, and the specific steps in the transesterification phase are as follows: The first step is that the temperature of diphenyl carbonate is rised to 100° C.-120° C. under inert gas protection. The second step is that bisphenol A is added and then the time of keeping temperature is 30-45 min. The third step is that the prepolymer is prepared by heating up to 150° C.-180° C. and the time of keeping temperature is 1-2 H. The specific steps of the condensation phase are as follows: The first step is that the temperature of the prepolymer is rised to 200° C.-220° C. under inert gas protection and then the time of keeping temperature is 45-60 min. The second step is that causing the temperature to rise to 240-270° C. and the time of keeping temperature is 1-2 H. The third step is that the reaction is kept 15-30 min under the condition of vacuum. Low molecular weight polycarbonate is acquired.

3. According to claim 1 wherein said, the preparation method of polyorganosiloxane-polycarbonate is described, its characteristic includes: in the step A1, the additive amount of the composite catalyst said is 0.4%-3% of the mass of the bisphenol A. The composite catalyst said is composed of catalyst A and catalyst B, the molar ratio of A:B is 1:0.8-1.5. The catalyst A said is one or more of the tetraphenyl phosphonium benzene oxide, tetraphenyl phosphonium acetate and phenol tetraphenyl phosphonium salts. The catalyst B said is one or more of t-butyllithium, t-butylpotassium, cesium tert-butyl, tert-butyl, n-butyllithium, n-butyl, n-butyl, and n-butylcaesium.

4. According to claim 1 wherein said, the preparation method of polyorganosiloxane-polycarbonate is described, its characteristic includes: The molar ratio of total diphenyl carbonate in steps A1 and B1 wherein said to bisphenol A in step A1 is 1:1.1-1.2. In the step A2 wherein said, the molar ratio of acyl chloride capping agent to bisphenol A is 5-10:1.

5. According to claim 1 wherein said, the preparation method of polyorganosiloxane-polycarbonate is described, its characteristic includes: In the step A2 wherein said, the acyl chloride capping agent said is vinyl benzenesulfonyl chloride and/or methyl propionyl chloride. In the step B1 wherein said, the polysiloxane said is a polydimethylsiloxane terminated by eugenol. The weight-average molecular weight of the polysiloxane said is 2500-3200, and the polydispersity index is less than 3.5.

6. According to claim 1 wherein said, the preparation method of polyorganosiloxane-Polycarbonate is described, its characteristic includes In the step B1 wherein said, the reaction temperature is 100° C.-120° C., at the end of the reaction, the product is cooled to 40° C.-60° C. In the step B2, the reaction temperature is 120° C.-150° C., and the time of keeping temperature is 45-60 min, and then vacuum extraction is operated, and then the time of keeping temperature is 15-20 min, the last the polyorganosiloxane-polycarbonate crude product is acquired by cooling down to normal atmospheric temperature.

7. According to claim 1 wherein said, the preparation method of polyorganosiloxane-polycarbonate is described, its characteristic includes: In the step B3 wherein said, organic solvents are one or more of dichloromethane, trichloromethane, dichloroethane, trichloroethane, tetrachloroethane, toluene, and chlorobenzene. Alcohol solvents are one or more of methanol, ethyl alcohol, propanol and butanol.

8. According to claim 1 wherein said, the preparation method of polyorganosiloxane-polycarbonate is described, its characteristic includes: In the step B3 wherein said, the weight-average molecular weight of the Polyorganosiloxane-polycarbonate is 40000-60000, and the polydispersity index is 1.5-2.2. The weight percentage of the polycarbonate block said is 70%-85%, and the polysiloxane block said is 15%-30%.

9. The characterized of modified polycarbonate includes raw materials weights as follow:
Polycarbonate: 100 PHR
Polyorganosiloxane-polycarbonate: 20-40 PHR
Hyperbranched polymer: 1-5 PHR
Halogen-free flame retardant: 0.1-0.6 PHR
Toughening agent: 0.5-4 PHR
Anti-drop agent: 0.3-0.5 PHR
Antioxidant: 0.16-0.3 PHR
Light stabilizer: 0.2-0.4 PHR
Dispersant: 0.4-0.5 PHR
The polyorganosiloxane-polycarbonate said is prepared by means of the preparation method described in claim 1.

10. Preparation method of modified polycarbonate is described in claim 9 wherein said, its characteristic includes the following steps:
(1) The polycarbonate and polyorganosiloxane-polycarbonate are dried at 100° C.-120° C. for 2-4 h.
(2) Hyperbranched polymers, flame retardants and partially polysiloxane-polycarbonate are mixed homogeneously, the mixing speed is 1000-1200 r/min, and the mixing time is 5-8 min, the flame retardant plastic masterbatch is prepared by extrusion granulation.
(3) The Homogeneous mixture contains the flame retardant masterbatch prepared in step (2), polycarbonate, antioxidant and the remaining polyorganosiloxane-polycarbonate and extruded to form plastic masterbatch.
(4) The toughening agent, anti-dropping agent, light stabilizer and dispersant are predispersed to obtain the pre-dispersed mixture.
(5) The product of step (3) is added to the pre-dispersed mixture of the step (4) wherein said, and the mixture is evenly mixed. Modified polycarbonate is acquired by extrusion granulation.
Wherein, the step (2), the step (3) and the step (5) wherein said are all extruded by a twin screw extruder.
In the step (2) wherein said, the temperature of each area of twin screw extruder is: the first area: 210-230° C., the second area: 250-260° C., the third area: 270-280° C., the fourth area: 270-280° C., the fifth area: 270-280° C., the sixth area: 270-280° C., the seventh area: 250-260° C., the eighth area: 250-260° C., the ninth area: 270-280° C., extruder head temperature: 270-280° C.
In the step (3) wherein said, the temperature of each area of twin screw extruder is: the first area: 180-200° C., the second area: 210-230° C., the third area: 220-240° C., the fourth area: 220-240° C., the fifth area: 220-240° C., the sixth area: 220-240° C., the seventh area: 210-230° C., the eighth area: 210-230° C., the ninth area: 220-240° C., extruder head temperature: 160-180° C.
In the step (5) wherein said, the temperature of each area of twin screw extruder is: the first area: 180-200° C., the second area: 210-230° C., the third area: 220-240° C., the fourth area: 220-240° C., the fifth area: 220-240° C., the sixth area: 220-240° C., the seventh area: 210-230° C., the eighth area: 210-230° C., the ninth area: 220-240° C., extruder head temperature: 160-180° C., The rotating speed of twin screw extruder is 350-400 r/min, the feed quantity is 170-180 kg/h, the vacuum degree is ≥600 mm Hg, and the temperature of water cooling is 40-65° C.
